(19) United States
(12) Patent Application Publication
(10) Pub. No.: US 2021/0012314 A1
(43) Pub. Date: Jan. 14, 2021

(54) SYSTEM AND METHOD FOR AGGREGATING GROUP MERCHANT TRANSACTIONS

(71) Applicant: Bonus Tempus, LLC, Ladson, SC (US)

(72) Inventors: Ryan Eleuteri, Ladson, SC (US); Evan Polk, Ladson, SC (US)

(73) Assignee: Bonus Tempus, LLC, Ladson, SC (US)

(21) Appl. No.: 16/505,955

(22) Filed: Jul. 9, 2019

(51) Int. Cl. G06Q 20/22; G06Q 20/40; G06Q 20/32

(52) U.S. Cl. CPC G06Q 20/29; G06Q 20/403; G06Q 2230/00; G06Q 20/325; G06Q 20/322

(57) ABSTRACT

Disclosed are various embodiments of methods, systems, and mobile application programs for multi-member group payment aggregation and settlement with a mobile computing device equipped with a mobile payment application. The aggregation engine enables the mobile payment application to aggregate the various members into a group and processes the financial contributions of the various group members into an aggregated fund. The transaction engine enables the aggregated multi-member group to transact a variety of payment transactions. Together the engines enable the multi-member group to conduct a variety of management, statistical, and processing of the aggregated funds.

### FIELD

The invention relates to a computer implemented method and system for aggregating a multi-member group fund and payment thereof.

### BACKGROUND

The present invention relates to aggregating funds for payment of goods and services. Presently, we see an exponential growth in software defined methods of purchasing and paying for goods and service. These advancements include digital wallets and tokens, as well as advancements to traditional chip cards “EMV” and magnetic strip cards.

Traditional payment methods include utilizing tangible payment methods that are exchanged at the time of purchase. Checks could be exchanged at the time of purchase but required a settlement period. Credit cards advanced payment by allowing instantaneous verification and payment by incorporating third parties to the transaction. Digital wallets remove the tangible feature of credit cards and add additional features through computer applications and software defined payment methods and applications.

These advances have brought a new wave of capability to how payments and transactions are conducted. However, as these new payment methods developed, a new problem presented itself as to how these disparate methods of payment can be accepted and utilized in an aggregate setting with multiple members to a group. There is an increasing need to handle a multitude of financial transactions through a plurality of individuals with each individual having a different payment device.

### BRIEF DESCRIPTION OF THE DRAWINGS

Many aspects of the present disclosure can be better understood with reference to the following drawings. The components in the drawings are not necessarily to scale, with emphasis instead being placed upon clearly illustrating the principles of the disclosure. Moreover, in the drawings, like reference numerals designate corresponding parts throughout the several views.

FIG. 1 is a schematic diagram of an example embodiment of a multi-member group mobile payment aggregation system and method; and

FIG. 2 is a schematic diagram of an example embodiment of the mobile payment application; and

FIG. 3 is a calling sequence of an example embodiment illustrating a series of events of a multi-member group mobile payment aggregation method; and

FIG. 4 is flowchart diagram of an example embodiment illustrating a series of components and events in the mobile payment application; and

FIG. 5 is a flowchart diagram of an example embodiment illustrating a series of events for merchant payment with a multi-member mobile payment aggregation system and method; and

FIG. 6 is a component diagram of an example embodiment of a mobile computing device system; and

FIG. 7 is a flowchart diagram of an example embodiment of the mobile payment application.

### DETAILED DESCRIPTION

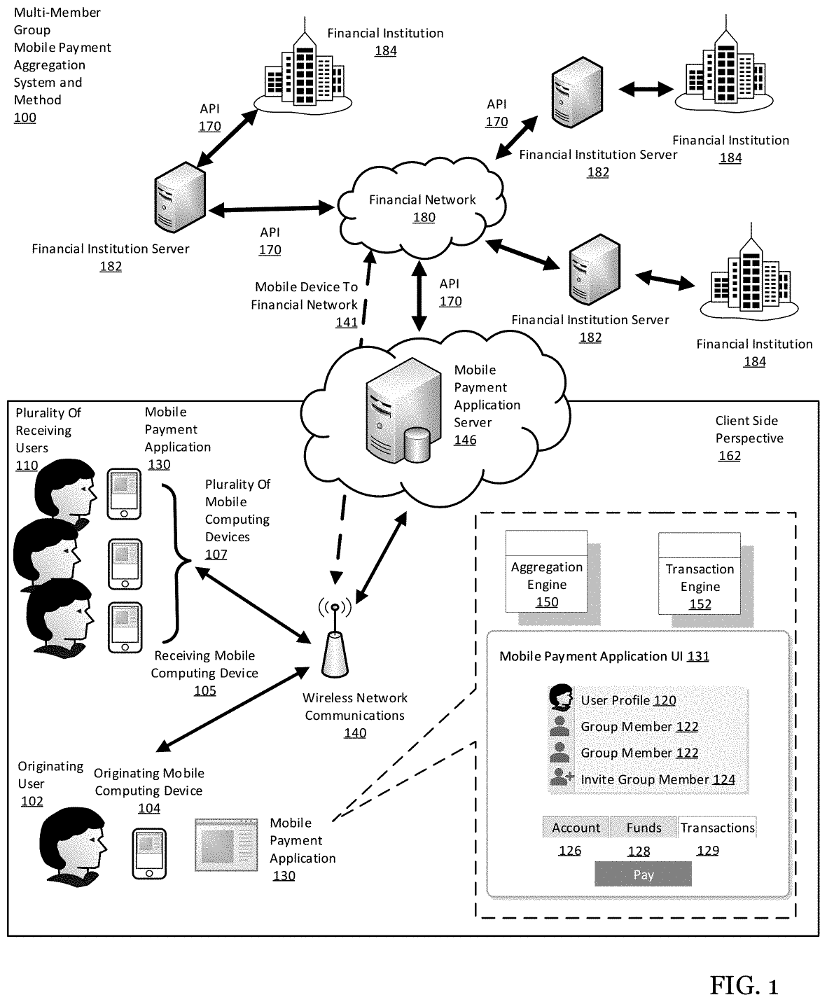

Embodiments of the present invention relate to improvements and advancements in multi-member group payment aggregation and multi-member group merchant payment. In the following discussion, a general description of the system and its components are provided, followed by a discussion of the method and operation of the same, beginning with FIG. 1.

FIG. 1 sets forth a schematic diagram of an example embodiment of the multi-member group mobile payment aggregation system and method (100). Starting with the originating user (102), the originating user (102) utilizing an originating mobile computing device (104) executing a mobile payment application (130) initiates a request through wireless network communications (140) to a plurality of receiving users (110). In the example embodiment of FIG. 1, the originating user (102) is named such as it is the user that makes the multi-member group payment request to a plurality of receiving users (110). In other embodiments, any number of the plurality of receiving users (110) can be the originating user (102) utilizing the originating mobile computing device (104) equipped with the mobile payment application (130).

In the example embodiment of FIG. 1, the originating mobile computing device (104) is a mobile computing device equipped with a mobile operating system along with sufficient hardware, including storage and memory to process a mobile payment application (130). Typical embodiments of a mobile computing device include Apple iPhone™, Apple iPad™, Apple MacBook™, Google Pixel™, Google Chromebook™, Samsung Galaxy™, or any other similar mobile computing device including laptops, notebooks, tablets, and smart phones.

The originating mobile computing device (104) is equipped to load, install, or execute the mobile payment application (130). The mobile payment application (130) operates as a standalone application with a mobile payment application user interface (131). The mobile payment application (130) is equipped to communicate through the wireless network communications (140) to a mobile payment application server (146). In the example embodiment of FIG. 1, the mobile payment application server (146) is a cloud server that is equipped to process and utilize the aggregation engine (150) and the transaction engine (152). In other embodiments, the mobile payment application server is a local server or a remote repository. In further embodiments, the aggregation engine (150) and the transaction engine (152) are client side within the mobile payment application (130) and executes on the plurality of mobile computing devices (104). The plurality of mobile computing devices (107) along with the originating mobile computing device (104) and the receiving mobile computing device (105) are interchangeable and are so labeled as to provide a series of steps to enable a person having ordinary skill in the art to understand a sample flow of communication and processes along with the systems required thereof.

The mobile payment application user interface (131), in the example embodiment of FIG. 1, includes a user profile (120), a group member profile (122), the ability to add a group member (124), the user's account (126), the available group funds (128), and previous group transactions (129). In the example embodiment, the user profile (120) defines a typical user account with name, address, date of birth, email, picture, avatar, and other characteristics of a user profile. The group member (122) is the profile for the group member including similar items such as name, address, date of birth, email, picture, avatar, and other characteristics of a user profile. The invite group member (124) invites new members to the group. In the present embodiment of FIG. 1, this option is available to the originating user (102), but also turned on for the plurality of receiving users (110) to add additional members to the multi-member group. In additional embodiments, the originating user (102) keeps complete control of invitations for the additional group members to the multi-member group. The account (126) menu option contains account information for the user and stores connections or API links to the various registered banking accounts at the financial institutions of the plurality of members to the multi-member group. The funds (128) menu contains the information for the aggregated funds of the group members. The transactions (129) menu stores previous transactions and reconciliations from the aggregated fund.

In the example embodiment of FIG. 1, the aggregation engine (150) is a computer implemented engine that assimilates the correspondence to the various group member invitations, processes the acceptance and denials, and processes the incoming funds along with the validation of such funds. The aggregation engine (150), in the example embodiment of FIG. 1, resides within the mobile payment application (130). In other embodiments, the aggregation engine (150) resides server side at the mobile payment application server (146). The aggregation engine of FIG. 1 compiles and transmits invitation requests to form a multi-member group fund from the originating mobile computing device (104). The one or more recipients of the request, displayed as the plurality of receiving users (110), receive the request on the receiving mobile computing device (105) equipped with the mobile payment application (130). Upon receiving the request, the mobile payment application (130) alerts the plurality of receiving users (110) with a notification to join the multi-member group fund. In the example embodiment, the alert displays on the receiving mobile computing device (105), whereas in additional embodiments the alert is a tone or a signal to the receiving users (110) to alert them of activity within the mobile payment application (130).

In the example embodiment of FIG. 1, the aggregation engine on the receiving devices communicates through the API (170), to a financial network (180), to a series of financial institution servers (182), for the various banking or financial institution (184) accounts that the receiving group of users maintain and have authorized within the mobile payment application (130). The aggregation engine operates through an API to confirm credit is available and to secure and authorize the transaction for the receiving user. The aggregated fund (128) is available for viewing by members to the multi-member group and the details are provided by the aggregation engine (150).

In the example embodiment of FIG. 1, the aggregation engine also transmits notifications across the plurality of mobile computing devices (107) when an event such as funding by an invited group member occurs. This alerting is similar to the alerting as previously discussed and can be in the form of a UI alert or audible or haptic alert. The aggregation engine further manages the bank's declining of available funds and transmits to the originating user (102) a decline of available credit from the financial institution of the user. Additionally, the aggregation engine (150) handles receiving user (110) decline form participation, as well as updating the total invited and confirmed group members. Many additional embodiments to the aggregation are available and some will be discussed in the additional figures. The aggregation engine (150), in the example embodiment, is but one of many configurations that comprise the spirit of the disclosure.

In the example embodiment of FIG. 1, the transaction engine (152) serves to receive an invoice or estimate, digitize the estimate or invoice by processing with through optical character recognition, discover the balance of the estimate or invoice, and transmit or process the estimate or invoice through a payment device. Additional embodiments disclose a manual addition of the estimate or invoice by the user and a computer-generated automatic split or user split of the invoice to the aggregated fund. It is important to note the aggregated fund may not be a single account and in other embodiments may be tied to the various members of the multi-member group's individual credit financial institutions (184). In the present embodiment of FIG. 1, the aggregated fund is of a deposit account that can be drawn on the members of the multi-member group for payment. However, the account may also be a line of available credit from the multi-member group or additional embodiments such as a checking account.

In FIG. 1, the transaction engine (152), processing on the mobile payment application (130), uses the available mobile computing device to take a photograph of the invoice. The photograph is digitized by optical character recognition and the total or balance is located by computer vision. The total amount is then transmitted by the transaction engine (152) to the plurality of mobile computing devices (107) through the wireless network communications (140) for viewing by the accepted members to the multi-member group. In the embodiment of FIG. 1, the alert by the transaction engine possesses a vote option wherein the accepted members to the multi-member group can vote to accept the transaction or decline the transaction. Circumstances arise when the payment device may be missing, or an individual incorrectly utilizes the payment device for a charge not designated to the multi-member group. In other embodiments, the vote parameter does not exist and is determined by the proximity of the members to the multi-member group. If the members of the multi-member group are within close proximity, the authorization is accepted by the plurality of members to the multi-member group. In additional embodiments, the vote is absent from the mobile payment system and the consent for use is acquired by the users prior to any payment transactions.

According to the example embodiment of FIG. 1, the transaction engine (152) processes the financial transaction between the multi-member group and the merchant. Example embodiments include the multi-member group dining at a restaurant or enjoying an evening out at a club. These embodiments are not inclusive, and many other embodiments are disclosed such as group purchases of goods, services, real estate property and leases, licenses, and other financial transactions that can be transacted by more than one individual. In FIG. 1, upon receiving the invoice and the total funds due, the transaction engine (152) accepts approval from the various members of the multi-member group and transmits payment to the merchant through a financial device. In later embodiments, a financial device is disclosed as a group credit card both digital and physical as well as a group check or other financial payment device that allows funds to transfer from one account to another. Following a merchant transaction, the transaction engine (152) transmits the transaction receipt to the multi-member group and adjust the funds available (128). In additional embodiments, the aggregation engine (150) reconciles the funds and transmits the transaction updates.

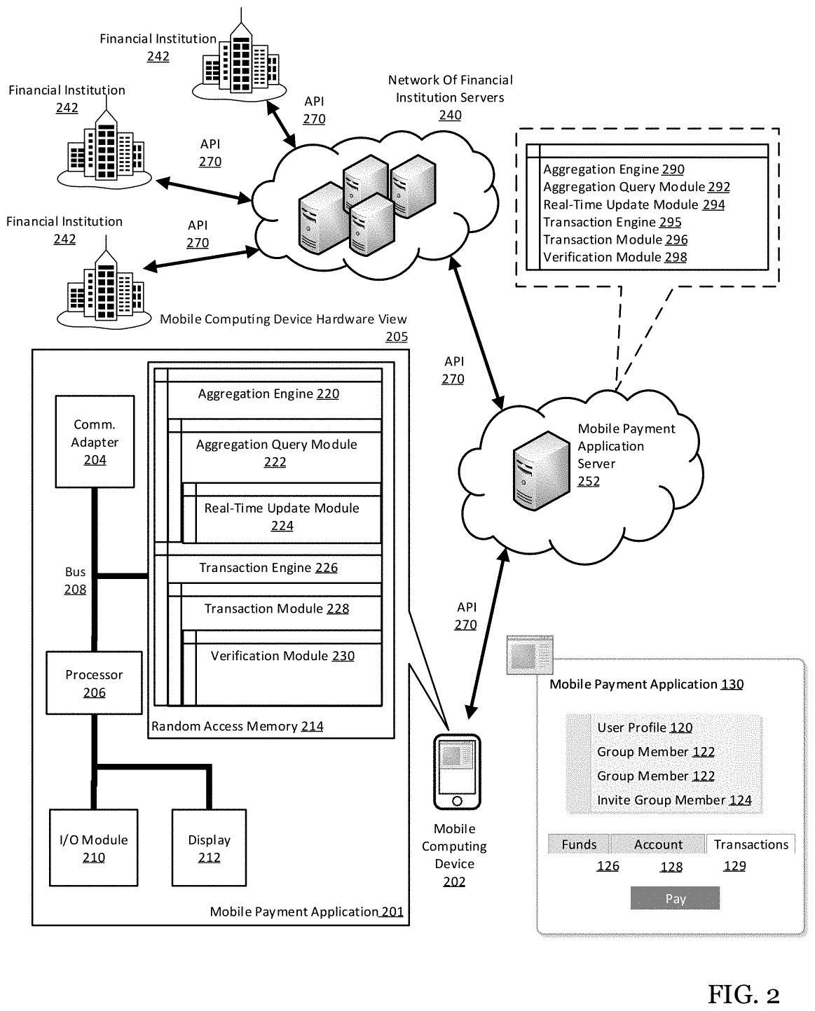

Turning now to FIG. 2, in the example embodiment of FIG. 2, we see a view of a schematic diagram of an example mobile payment system according to the disclosure. The mobile payment application (201) is shown with the mobile computing device hardware (205). The mobile computing device (202), in the example embodiment of FIG. 2, is equipped with a communications adapter (204), wherein the communications adapter is configured to a bus (208) to communicate with the various hardware aspects of the mobile computing device hardware (205). The processor is configured to execute the mobile payment application (201) through the aggregation engine (220) and the transaction engine (226). The I/O module (210) is configured to produce the user interface for the mobile payment application (201) and render the application on the display (212) of the mobile computing device (202).

In the example embodiment of FIG. 2, the random access memory (214) stores the mobile payment application (201) equipped with the aggregation engine (220) and the transaction engine (226). The aggregation engine (220) utilizes the query module (222) in querying the multi-member group for connection of accounts and formation of the multi-member group fund. The query module, in the example embodiment, queries the plurality of mobile computing devices equipped with the mobile payment application and facilitates the responses of accept or decline as well as the authorization of the credit for the plurality of members in the multi-member group. The real-time update module (224) syncs in real time the value of the funds and the status of the current group members of the multi-member group. In the example embodiment of FIG. 2, the real-time update module (224) is equipped to locate the members of the multi-member group for location validation in the transaction engine (226). In additional embodiments, the real-time update module serves as a relay to the mobile payment application server in communicating aspects of the aggregation engine on the plurality of mobile computing devices equipped with the mobile payment application.

In the example embodiment of FIG. 2, the transaction engine (226) is equipped to scan, perform optical character recognition, accept user input, establish payment, reconcile any payments, receive member vote, and verify and record the transaction. Taking the various items in turn, the scanning occurs through the hardware of the mobile computing device's (202) on board camera, then the transaction engine reads the image scan into a portable document format for processing with optical character recognition. In other embodiments, the invoice amount is manually entered by the user. In still further embodiments, the invoice amount is transferred from the merchant to the mobile computing device (202) equipped with the mobile payment application (201) for receipt and processing of a digital invoice. The transaction engine (226) establishes payment by transferring the requested funds in the invoice to the merchant. The transaction engine (226) establishes payment through various means including by check, credit, or token to satisfy the obligation on the merchant invoice.

In FIG. 2, the transaction engine (226) is equipped to handle a member vote, wherein the verification module sends alerts to the plurality of members in the multi-member group regarding a new payment invoice. The members of the multi-member group are thus given a user interface alert of the invoice, their allotted payment, and an icon to approve or decline the payment. In other embodiments, the consent is given at the onset of the multi-member group formation. In still further embodiments, the members consent by location dependency at the time the transaction is initiated. All of these embodiments are examples and there are other means available for verifying the transaction, all of which will be known to those of skill in the art.

In the example embodiment of FIG. 2, the mobile payment application server (252) is equipped with the mobile payment application engines (290, 295) in order to process the items in a cloud environment. It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed. Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service.

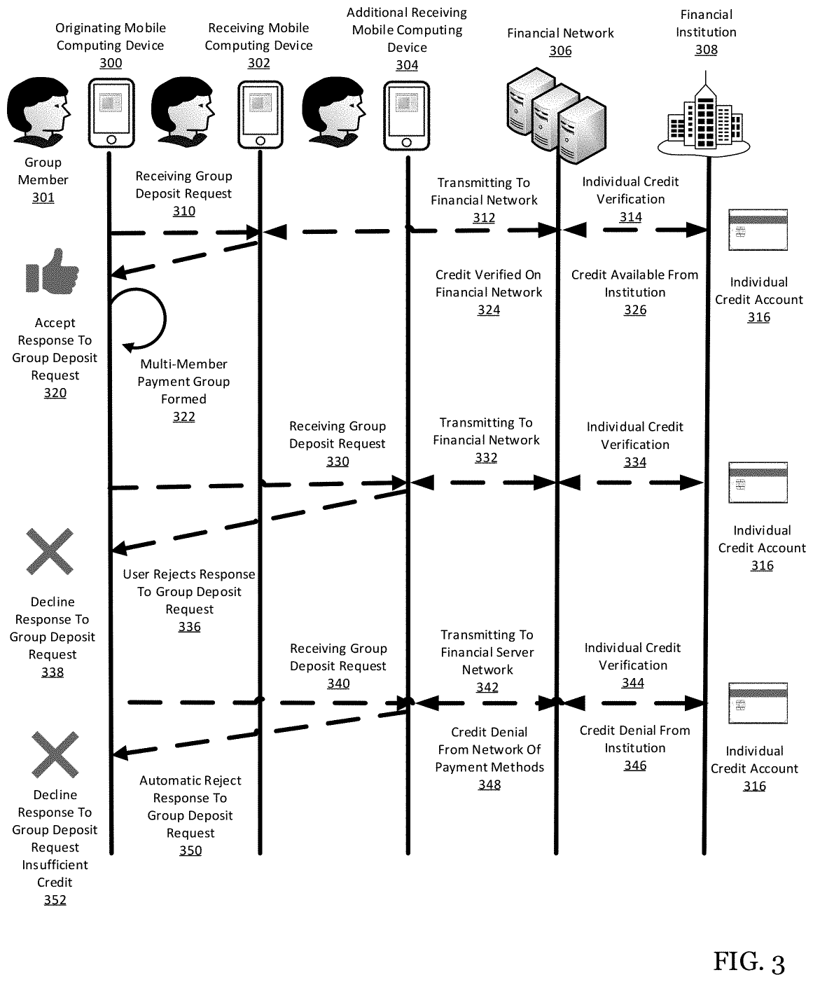

Turning now to the example embodiment of FIG. 3. FIG. 3 is a calling sequence, illustrating a series of events of a multi-member group mobile payment aggregation method and system as disclosed herein. The originating mobile computing device (300) transmits a request to a receiving group member for a group deposit (310). The receiving mobile computing device (302) receives the request and displays it to the receiving user, along with additional details such as invited group members and fund amount requested. The receiving mobile computing device (302), equipped with the mobile payment application, transmits the user's credentials to the financial network (312) for verification of funds. The financial network (306) verifies the individual credit (314) with the user's financial institution (308).

In other embodiments, the financial network is not utilized and the mobile payment application on the receiving mobile computing device connects directly with the user's financial institution (308) for individual credit account (316) validation. An individual credit account can be a credit card, a line of credit, a checking account, a deposit account, a coin or token account, or a savings account in which the user has established at a financial institution. The financial institution (308) verifies that credit is available (326) and transmits through the financial network (306) to the receiving mobile computing device (302) the available requested funds that have been verified (324). The mobile payment application's aggregation engine then adds the funds to the multi-member group fund and transmits the acceptance response to the group deposit (320) along with the funds. In the example embodiment, when transmitting the funds, a separate account is created and deposited through the mobile payment application utilizing a preferred financial institution. In other embodiments, the account is held in a central pool of credit and the transactions are allotted to the multi-member group through a group ID. A group ID is an identification of the account value within a pool of resources. When the originating user and at least one other member subscribe to the transaction and verify credit, the multi-member payment group is formed (322). Formation then establishes the account and the payment device for use in multi-member payment transactions.

In the second scenario of the calling sequence diagram of FIG. 3, the multi-member group request is transmitted to an additional receiving mobile computing device (304) of an additional group member for acceptance or denial. The aggregation engine immediately begins to verify credit prior to the receiving user issuing a denial of the multi-member group fund request. User selected denial will transmit to the originating device (336) a denial and the originating mobile computing device (300), equipped with the mobile payment application, will process the denial through the aggregation engine by removing the user from the multi-member group and alerting the other members to the invitation denial. In additional embodiments, the request to the financial institution may be halted until and unless an approval by the receiving user on the receiving mobile computing device is obtained.

In the third scenario of the example embodiment, a credit denial is illustrated. As in the first and second scenario, the request from the originating group member (301) on the originating mobile computing device (300) is sent to an additional receiving mobile computing device (304). The additional receiving mobile computing device (304) performs a credit check and validation that funds are available through the financial network (306) to the user's financial institution (308), verifying the individual credit account (316). The verification from the financial institution results in a denial of credit regardless of the receiving user's response, and an automatic denial of the group deposit request is sent from the additional receiving mobile computing device. In other embodiments, the denial is not automatically sent but the acceptance is removed until the user can successfully verify the funds are available with the individual user's financial institution. The fetching of credit is done on a recurring basis and is set to attempt retransmission if a network failure occurs. In other embodiments, the fetch of credit is based upon user preference or user selection and is dependent upon the user's financial institution.

In the example embodiment of FIG. 3, once a denial is transmitted (350) due to the user's credit, the additional receiving user is dropped from the group deposit request and all members of the multi-member group are notified of the invitation decline. In additional embodiments, only the originating user is notified of the member decline and the originating user transmits the update to the plurality of receiving mobile computing devices in a passive manner without notification. In yet another embodiment, the decline is transmitted to all receiving and originating user's mobile computing devices in a passive manner and notification is silent. This is beneficial when groups become exceedingly large and the notifications would cause user frustration.

In FIG. 3, the individual credit accounts (316) represent the credit accounts of the various users. These credit accounts are typical accounts with a financial institution as discussed previously. When a multi-member group fund is formed, the individual credit accounts transact the appropriate requested funds to the multi-member group fund through the aggregation engine. The aggregation engine reconciles the funds and displays the funds on the mobile payment application on the plurality of mobile computing devices.

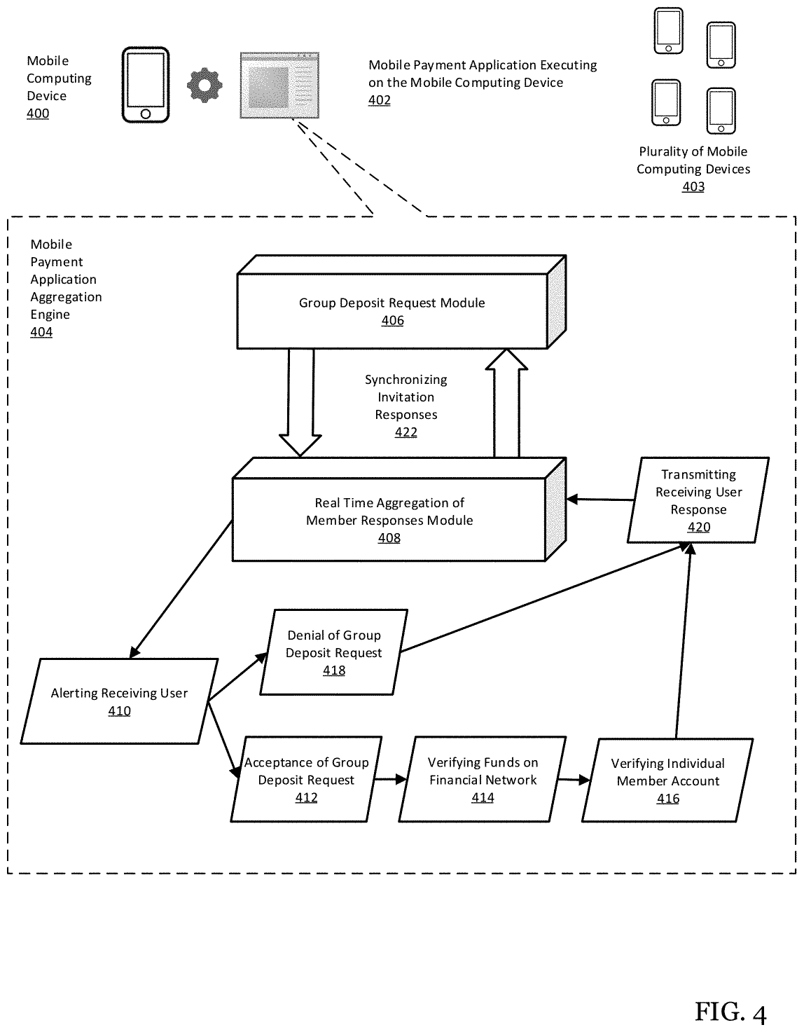

Our focus now on FIG. 4, representing an example embodiment of a flow diagram showing one example of the mobile payment application with the aggregation engine (404). The mobile computing device (400) processes the mobile payment application by executing it on the mobile computing device (402). When executed, the mobile payment application is loaded in random access memory where the processor interprets commands from the application. The mobile payment application is based upon a high-level language and typical languages include objective C, Java, or Python, along with libraries and components for individual functionality. For instance, on Android™ devices the application will render in a Java based language, while in Apple iOS™ the program may run in objective C. The language is not a limiting factor and is merely set out for example.

Focusing now on the mobile payment application aggregation engine (404) of FIG. 4, the aggregation engine initiates a group deposit request module (406) for the group deposit request. Wherein initiating the group deposit request module initiates the transmittal of a request for a group deposit to the receiving devices and begins the process of seeking validation from the receiving users. In seeking validation, the originating device is open to communication from the plurality of receiving mobile computing devices wherein the mobile payment application is communicating to the plurality of invited members. The synchronizing invitation of responses (422) is an active based module that seeks to continually update the status of the plurality of users with the mobile payment application.

The real-time aggregation of member responses (408) is a module within the mobile payment application aggregation engine (404) that operates in real-time to alert the receiving user (410) of a multi-member group deposit request. Wherein notifying includes a visual display through the user interface on the mobile computing device (400), audible through the mobile computing device (400), as well haptic through the mobile computing device (400).

Upon receiving an alert from the originating mobile computing device, the user is prompted to accept the group deposit request (412) or deny the group deposit request (418). The user can customize and configure automatic acceptance by specifying the originating user or originating event. In the example embodiment of FIG. 4, a denial of the group request (418) transmits (420) from the receiving user to the originating user through the real time aggregation member responses module (408) and synchronizes (422) the events across the plurality of devices (403) through the group deposit request module (406) on the aggregation engine (404). The synching occurs over cellular transmission, wireless transmission, or Bluetooth transmission to the other devices. Additional embodiments such as near field communication or wired communication are available to facilitate the transfer of information from the mobile payment application on the plurality of mobile computing devices.

Turning back to the alerting a receiving user (410), the acceptance of the group deposit request (412) initiates a sequence to verify the funds on the financial network (414) of the user. Wherein verifying the funds (414), the mobile payment application, utilizing the aggregation engine, fetches the credit information of the user (416) and returns validation from the users individual financial institution. The aggregation engine (404) then transmits (420) to the originating user and the plurality of receiving users the response along with a real time aggregation of member responses (408). In additional embodiments, the originating user reconciles the real time aggregation of member responses, while in other embodiments the receiving device sends the confirmation to the plurality of mobile computing devices (403), and yet in another embodiment the mobile payment application server handles the real time aggregation of member responses.

In the example embodiment of FIG. 4, the flow diagram of the method and system is but one example of a numerosity of configurations that will allow the aggregation engine to assemble the members of the multi-member group, verify their respective approval or denial, and verify the respective availability of funds or credit. The aggregation engine (404) is equipped to accept numerous modules and work with the hardware of the mobile computing device (400) for functionality with the mobile camera, touch input, flashlight, audible, haptic, and any other features that would be present on a mobile computing device.

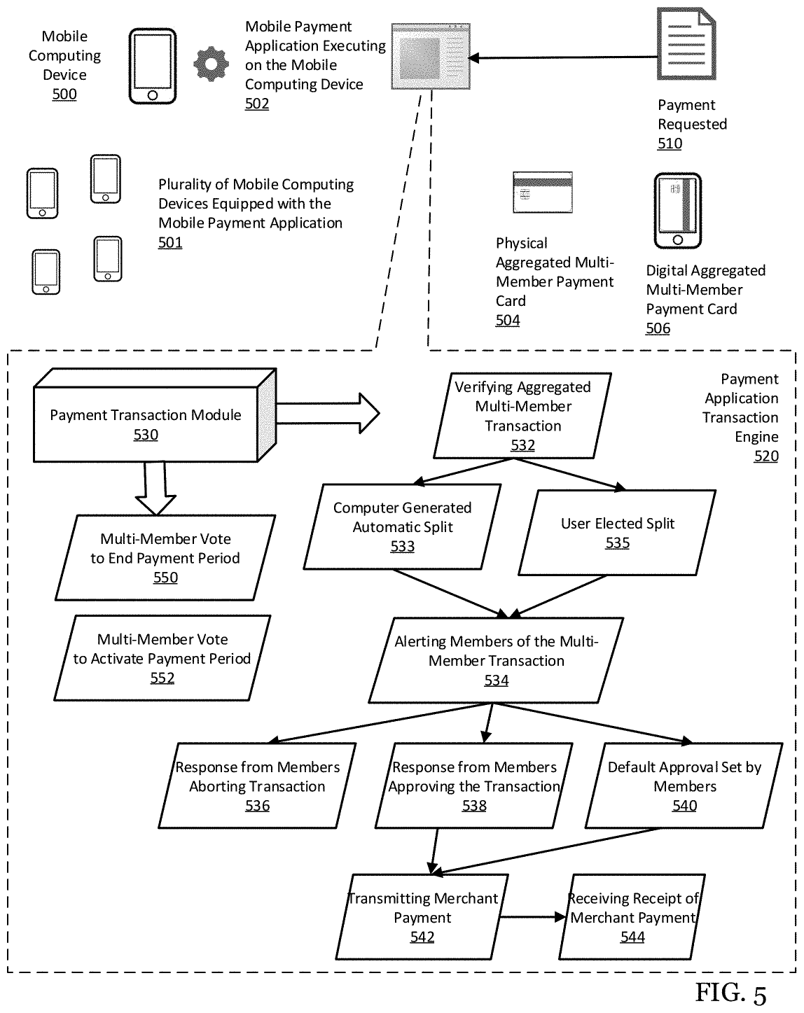

In the example embodiment of FIG. 5, a flowchart diagram illustrates a series of events for merchant payment with a multi-member mobile payment aggregation system and method. The mobile computing device (500) has running in random access memory, or the ability to run in random access memory, in the mobile payment application (502). The mobile computing device (500) receives a request from a merchant for a payment (510). The mobile payment system accepts the request through the payment transaction module (530). The payment transaction module (530) utilizes the hardware capabilities of the mobile computing device (500) to receive the payment request through user input. In additional embodiments, the payment request is received by the payment transaction module by the camera of the mobile computing device (500), wherein the camera scans the receipt into portable document format and then optically recognizes the characters to find the total or sum of items, or by producing the various invoice or payment request (510) into digital format for the user to view.

The payment transaction module of FIG. 5 executes two operations when a payment is requested. First, the payment transaction module sends out a multi-member vote to end payment on the payment device (550) or to activate for a payment period (552). The vote operation and activation period are user defined and can be toggled on and off. In the example embodiment of FIG. 5, the multi-member vote to end payment period (550) is set to automatically authorize payment when the plurality of mobile devices are located within close proximity of one another. The payment transaction module (530) locates whether the devices are in close proximity by identifying through the mobile computing device (500) the global positioning of the plurality of invited and accepted members of the multi-member payment group.

The second operation of the payment transaction module (530) is to verify the aggregated multi-member transaction. Wherein verifying the transaction, the module locates the total for the payment requested and delegates whether to send the transaction for a computer-generated automatic split (533) or a user elected split (535). The computer-generated automatic split (533) is a split of the invoice between the active credit lines for the multi-member fund group. The computer-generated automatic split in an additional embodiment would not apply toward a pre-aggregated group fund, wherein the fund is in a checking or a savings account ready for automatic distribution. The computer-generated automatic split (533) is utilized mainly online of credit wherein the charge can be split between the plurality of members of the multi-member payment group. The user elected split allows users to define the effective amount of split they wish to be responsible for. One additional embodiment feature of the user defined split occurs inside the payment transaction module (530) and allows for a pie graph chart showing the various contributions of the multi-member payment group. This chart is set to reflect the total payment of 100% but can be configured for other invoice amounts and percentages including tips and other externalities. The user elected split therefore improves the user experience by allowing a variety of contribution percentages towards the total of a payment request or invoice. In the example embodiment, the selected split is determined by the originating mobile computing device as the originating device acts as the lead device when forming the group. In other embodiments, the split can be determined by a vote or the split can be predetermined in advance and set by the multi-member payment group.

In accordance with FIG. 5, once the split occurs the members are notified of their respective share and in the example embodiment provided have a choice on whether or not to abort the transaction (536), approve the transaction (538) or have the options not available and set to default values (540). The customization of allowing final approval increases the security of the application and allows for greater customization of the platform. Upon approval of the request, the payment transaction module transmits payment to the merchant (542) and confirms receipt thereof by the merchant (544). Wherein the transmittal of payment is through either the physical aggregated multi-member payment card (504) or the digital aggregated multi-member payment card (506). The physical aggregated multi-member payment card is known also as a payment device within this application and resembles that of a modern day “EMV” or chip card. Additional embodiments of physical aggregated multi-member payment cards are magnetic strip cards, gift cards, and other physical devices that are known by those of skill in the art to facilitate the transaction of financial value from a customer to a merchant. The digital aggregated multi-member payment card (506) is a digital card found on the user's mobile computing device that is used to facilitate a transaction from a user to a merchant. Common digital cards include digital wallet cards that provide authorization of payment.

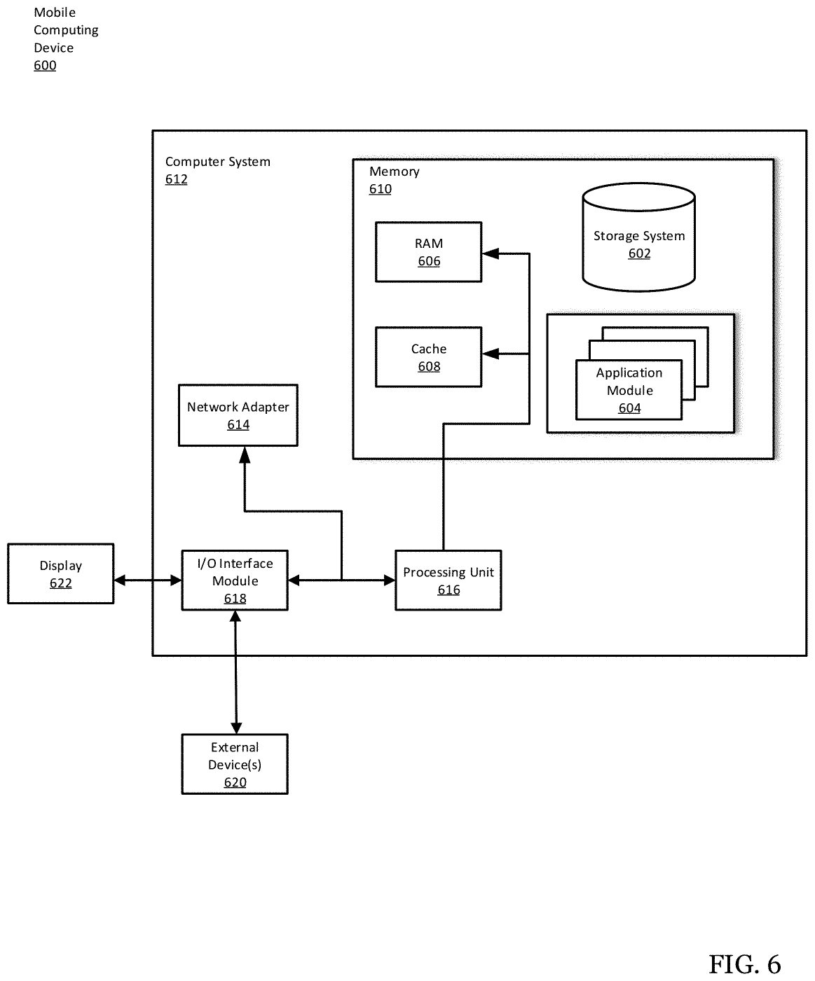

FIG. 6 is a component diagram of an example embodiment of the mobile computing device system. In the example embodiment of FIG. 6, the computer system (612) of the mobile computing device (600) is comprised of several components. The computer system (612) contains a storage system (602) that is comprised of solid-state drive technology or may also be equipped with other hard drive technologies for storage of computing information. For example, the mobile payment application may also reside in long term storage (602). The memory (610) of the example embodiment mobile computing system (612) also contains random access memory (606) which holds the program instructions along with a cache (608) for buffering the flow of instruction to the processing unit (616). Often times the executed mobile payment application (604) will reside in random access memory (606) as instructions are executed by the processing unit (616).

In the example embodiments of FIG. 6, the processing unit travels through a bus to the network adapter (614) that facilitates communications via network cards, wireless, Bluetooth®, and local area network adapters. The processing unit (616) is further configured through a bus to the input output interface module (10′) (618), the 10 module is connected to the display (622) which displays the GUI of the mobile payment application. The 10 module (618) is further configured to interface with many other external devices (620) such as universal serial bus adapters, lightning ports, power ports, and a whole host of additional 10 devices that are traditionally found interfacing with a general-purpose and/or special purpose computing device. FIG. 6 is but one example embodiment of the configured mobile computing device (600). Additional configurations and components of a general-purpose and special purpose computing device are disclosed herein.

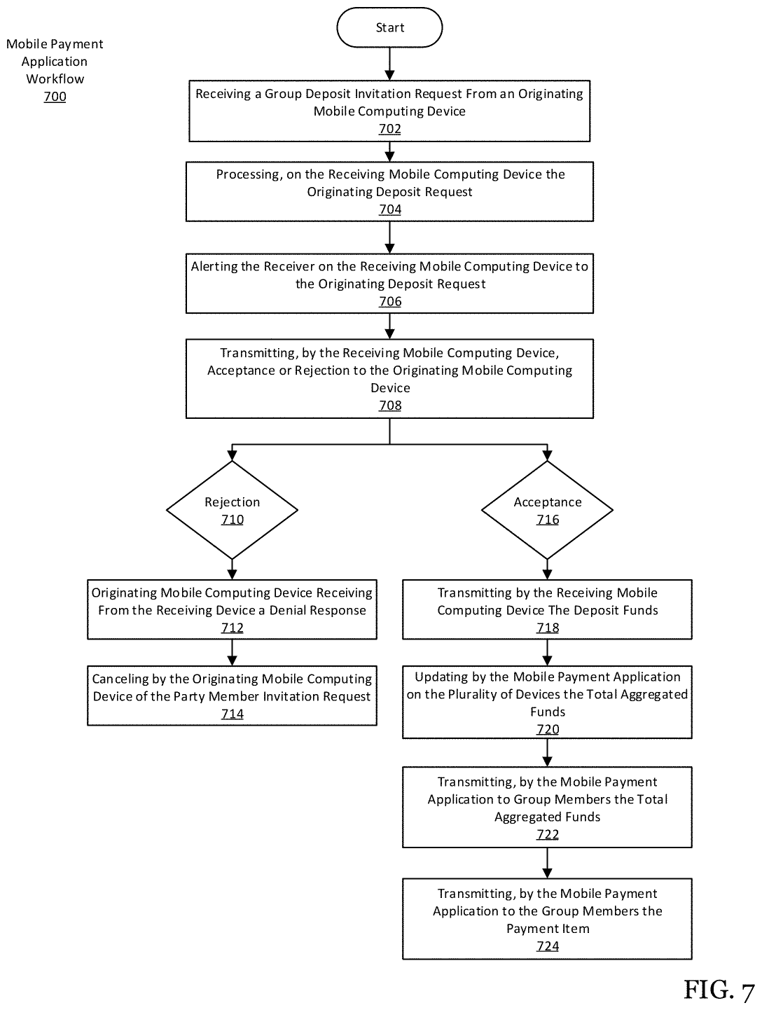

Turning now to FIG. 7. FIG. 7 is a flowchart diagram of an example embodiment of the mobile payment application. The mobile payment application workflow (700) is just one embodiment of a multitude of workflows in which the mobile payment application aggregates members to the multi-member group and processes the funds and transactions of the multi-member group.

The mobile payment application workflow (700) begins with receiving a group deposit invitation request from an originating mobile computing device (702). The originating mobile computing device transmits this request through a network to at least one other mobile computing receiving devices equipped with the mobile payment application. An exemplary network would be a cellular network using 5g, 4g LTE, 3g, or other cellular standard to transmit data to and from mobile computing devices. The data is communicated through a network card installed as hardware on the plurality of mobile computing devices.

In the example embodiment of FIG. 7, once the receiving mobile device receives the request it begins processing the deposit request (704), whereby processing occurs within the mobile payment application utilizing the aggregation engine. The aggregation engine prompts the receiving user to the request, alerting the receiver (706) of the deposit request by the originating device. The receiving user (708) may elect to reject (710) or accept (716) the group deposit request. In a rejection (710) scenario, the originating mobile computing device would receive from the receiving mobile computing device a denial of the group deposit request (712). Once the denial request is received the originating mobile computing device would cancel the invitation request (714) to the receiving party and terminate the transaction to the specific receiving member.

In the example embodiment of FIG. 7, in an acceptance (716) scenario, the receiving mobile computing device transmits the deposit funds (718) to the account specified by the originating mobile computing device. Upon transmitting, there is a financial institution verification which normally occurs over a financial network of computers and devices. Once communication is established and funds verified, the receiving device can transmit the instruction to the user's financial account at the user's financial institution for transmission or transfer to the account specified by the originating mobile computing device. The originating mobile computing device, having received the funds from the receiving mobile computing device, updates on the mobile payment application for the plurality of mobile computing devices, the total aggregated funds (720). The total aggregated funds are then transferred by the receiving device to the plurality of members of the multi-member group that have accepted the group deposit request and have funded the group deposit request.

In the example embodiment of FIG. 7, once the aggregated multi-member group fund is formed, the originating user transfers the payment device. In the example embodiment, this is a virtual card for a digital wallet for use in payment of merchant transactions. In an additional embodiment, the originating user receives an “EMV” card or a magnetic strip card for the account and has a tangible card associated with the multi-member group account. In yet another embodiment, all members receive a tangible card associated with the multi-member group account. For additional security, the tangible card is equipped with a rotating pin identification number that is available in the mobile payment application for processing a transaction. The mobile pin inside the mobile payment application is just one embodiment. In other embodiments the pin is located on the tangible card.

Aspects of the present invention are described herein with reference to flowchart illustrations and/or block diagrams of methods, systems, apparatus, and computer program products according to embodiments of the invention. It will be understood that each block of the flowchart illustrations and/or block diagrams, and combinations of blocks in the flowchart illustrations and/or block diagrams, can be implemented by computer readable program instructions.

The flowcharts, schematic diagrams, block diagrams, and calling sequences in the figures hereto illustrate the architecture, functionality, and operation of possible implementations of systems, methods, and computer program products according to various embodiments of the present invention. In this regard, each block in the flowcharts or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, can be implemented by special purpose dedicated hardware-based systems that perform the specified functions or acts or carry out combinations of special purpose hardware and computer instructions.

It should be emphasized that the above-described embodiments of the present disclosure are merely possible examples of implementations set forth for a clear understanding of the principles of the disclosure. Many variations and modifications may be made to the above-described embodiments without departing substantially from the spirit and principles of the disclosure. All such modifications and variations are intended to be included herein within the scope of this disclosure and protected by the following claims.

Therefore, the following is claimed:

1. A system for multi-member group mobile merchant payment aggregation through a payment network, the system comprising:
at least one or more mobile computing devices, the one or more mobile computing devices equipped to communicate to a plurality of mobile computing devices; and
the one or more mobile computing devices having a mobile payment application, the mobile payment application comprising:
a graphical user interface;
a mobile payment aggregation engine; wherein the mobile payment aggregation engine is equipped to communicate with a network of financial servers and the plurality of mobile computing devices;
a mobile payment transaction engine; wherein the mobile payment transaction engine is equipped to settle a financial transaction;
where the one or more mobile computing devices, equipped with the mobile payment application executing the mobile payment aggregation engine, are set to receive information from one or more financial network servers; and
where the one or more mobile computing devices, equipped with the mobile payment application executing the mobile payment aggregation engine, are further set to receive information from the plurality of mobile computing devices, the plurality of mobile computing devices being equipped with the mobile payment application executing the mobile payment aggregation engine.

2. The system of claim 1, wherein the mobile payment aggregation engine resides on a remote server and is accessed through network communications on the one or more mobile computing devices equipped with the mobile payment application.

3. The system of claim 1, wherein the mobile payment aggregation engine is equipped to perform real-time updates utilizing the network communications of the one or more mobile computing devices equipped with the mobile payment application.

4. The system of claim 1, wherein further comprising a database server, wherein the database server maintains records of the accounts for the plurality of mobile computing devices equipped with the mobile payment application.

5. The system of claim 1, wherein the mobile payment transaction engine is equipped to asynchronously process merchant payment transactions.

6. The system of claim 1, wherein the mobile payment transaction engine is equipped to communicate over a wireless network to verify the financial funds are available to process the transaction.

7. The system of claim 1, wherein the mobile payment transaction engine is equipped to display within the mobile payment application, transaction history of the goods or services for which the payment transaction has initialized.

8. A method for multi-member group payment aggregation on a mobile payment application, the method comprising:
receiving, by the mobile payment application on a receiving mobile computing device, an invitation request to a group deposit to a financial account; wherein the receiving mobile computing device receives the invitation request from an originating mobile computing device equipped with the mobile payment application;
processing, by the mobile payment application on the receiving mobile computing device, the invitation from the originating mobile computing device equipped with the mobile payment application requesting a deposit to a financial account; wherein processing the mobile application executes a mobile payment aggregation engine that identifies additional members to the originating mobile computing device's request;
alerting, by the mobile payment application on the receiving mobile computing device, the invitation requesting a deposit to a financial account; wherein alerting the receiving mobile computing device displays the request from the originating mobile computing device with a list of members that the originating mobile computing device has added to the request;
transmitting, by the mobile payment application on the receiving mobile computing device, a response to the originating mobile computing device equipped with the mobile payment application; wherein the response includes at least the acceptance or the rejection of the invitation request;
synchronizing, by the mobile payment application on the receiving mobile computing device, in accordance with the one or more members displayed by the mobile payment aggregation engine, the responses from the plurality of members added by the originating mobile computing device equipped with the mobile payment application;
reconciling, by the mobile payment application on the plurality of the mobile computing devices, in accordance with the mobile payment aggregation engine the total aggregated funds for the multi-member group; wherein reconciling accumulates the total fund transfers from the plurality of mobile computing devices that have received and accepted an invitation request; and
displaying, by the mobile payment application on the plurality of mobile computing devices, in accordance with the mobile payment aggregation engine the total aggregated funds for the multi-member group on the plurality of mobile computing devices that have received and accepted an invitation request.

9. The method of claim 8, wherein the plurality of mobile computing devices equipped with the mobile payment application, continuously synchronize over available communication protocols during intermittent network activity.

10. The method of claim 8, wherein the mobile payment aggregation engine identifies group members to the initial request from the second computing device equipped with the mobile payment application; wherein identifying includes aggregating group member profiles and financial information.

11. The method of claim 8, wherein the mobile payment aggregation engine communicates through a network to the group members stored financial accounts to process financial transaction requests from the originating mobile computing device.

12. The method of claim 8, wherein the originating mobile computing device equipped with the mobile payment application configures authority to the receiving mobile computing device to allow additional mobile receiving devices equipped with the mobile payment application to receive invitations to the aggregated payment.

13. The method of claim 8, wherein the receiving mobile computing device equipped with the mobile payment application processes by adding additional receiving group members to the originating mobile computing device's request.

14. The method of claim 8, wherein reconciling on the plurality of the mobile computing devices includes transmitting the available balance to the plurality of the mobile computing devices equipped with the mobile payment application.

15. The method of claim 8, wherein reconciling on the plurality of the mobile computing devices equipped with the mobile payment application is additionally processed by the mobile payment transaction engine; wherein the mobile payment transaction engine updating changes the available reconciled balance across the plurality of mobile computing devices.

16. A method for multi-member group payment to a merchant through a mobile payment application, the method comprising:
receiving, by the mobile payment application on a receiving mobile computing device, a request for payment by a merchant; wherein the request is for a multi-member group payment;
processing, by the mobile payment application on the receiving mobile computing device, on the mobile payment transaction engine; wherein processing verifies the available aggregated funds from the multi-member group and transfers the funds to the merchant;
displaying, by the mobile payment application on the receiving mobile computing device, in accordance with the mobile payment transaction engine, verification of the transfer of the requested funds by the merchant to the plurality of mobile computing devices utilized by the multi-member group;
updating, by the mobile payment application on the receiving mobile computing device, in accordance with the aggregation engine across the plurality of mobile computing devices equipped with the mobile payment application, the balance and transaction history for the multi-member group aggregated funds.

17. The method of claim 16, wherein the aggregation engine is processing on a remote server and transfers the requested information through a wireless network.

18. The method of claim 16, wherein the transaction engine is processing on a remote server and transferring the requested information through a wireless network.

19. The method of claim 16, wherein receiving the request for a multi-member group payment, further comprises scanning the merchant invoice with the mobile computing device equipped with the mobile payment application.

20. The method of claim 16, wherein receiving the request for a multi-member group payment, further comprises a multi-member group vote to activate the payment device and to deactivate the payment device.
